(19) United States
(12) Patent Application Publication
(10) Pub. No.: US 2013/0049984 A1
(43) Pub. Date: Feb. 28, 2013

(54) WIRELESS MONITORING SYSTEMS FOR USE WITH PRESSURE SAFETY DEVICES

(71) Applicant: Ronald D. Harper, JR., Georgetown, IN (US)

(72) Inventor: Ronald D. Harper, JR., Georgetown, IN (US)

(21) Appl. No.: 13/541,363

(22) Filed: Jul. 3, 2012

Related U.S. Application Data
(60) Provisional application No. 61/505,306, filed on Jul. 7, 2011.

(51) Int. Cl. G08C 15/06

(52) U.S. Cl. 340/870.02

(57) ABSTRACT

Wireless monitoring systems for use with pressure safety devices are described. An example wireless monitoring system includes a field device and a wireless transceiver coupled to the field device to receive a signal generated by the field device. The wireless transceiver has a self-contained power module. A wireless interface is communicatively coupled to the wireless transceiver without an interposing intrinsically safe barrier panel. The wireless interface wirelessly receives the signal from the wireless transceiver.

### CROSS-REFERENCE TO RELATED APPLICATION

This patent claims the benefit of U.S. Provisional Patent Application Ser. No. 61/505,306, filed on Jul. 7, 2011, entitled “WIRELESS MONITORING SYSTEMS FOR USE WITH PRESSURE SAFETY DEVICES,” which is hereby incorporated herein by reference in its entirety.

### FIELD OF THE DISCLOSURE

This patent relates to pressure safety devices and, more specifically, to wireless monitoring systems for use with pressure safety devices.

### BACKGROUND

Process control systems use a variety of field devices to control and/or monitor process parameters. For example, pressure of a fluid in a containment vessel is a parameter that is typically monitored in a process control system. Pressure relief valves and rupture disks are often employed as safety devices to prevent over pressurization or under pressurization of a fluid (e.g., a liquid, a gas, fluid power) in a containment vessel. For example, a pressure relief valve enables pressure within the containment vessel to be relieved when an operating pressure of a fluid within the containment vessel exceeds a pressure rating of the pressure relief valve. A rupture disk is a sensor that provides a signal or indication that pressure is being relieved from the containment vessel (e.g., via the pressure relief valve, directly to atmosphere via the rupture disk, etc.).

Monitoring devices are often hardwired to a control system. However, hardwiring a monitoring device to a control system significantly increases costs. Additionally, monitoring devices used in hazardous conditions or areas require intrinsically safe (IS) power modules or panels that provide power to a sensor of the monitoring device. The panel is then hardwired to a control system located in a non-hazardous area. Such a configuration significantly increases costs.

### SUMMARY

An example wireless monitoring system includes a field device and a wireless transceiver coupled to the field device to receive a signal generated by the field device. The wireless transceiver has a self-contained power module. A wireless interface is communicatively coupled to the wireless transceiver without an interposing intrinsically safe barrier panel. The wireless interface wirelessly receives the signal from the wireless transceiver.

An example method for monitoring a system includes monitoring a fluid characteristic of a process fluid via a field device and communicatively coupling the field device to a wireless transceiver that provides an intrinsically safe certification for use in a hazardous location. The method also includes sending a signal generated by the field device to a wireless interface via the wireless transceiver without the use of an intrinsically safe barrier.

An example wireless field device assembly includes a field device having a sensor to monitor a fluid parameter of a process fluid. The sensor generates an electrical signal when the fluid parameter is greater than or less than a pre-set value. A wireless transceiver is coupled to the field device and has a self-contained power module to provide an intrinsically safe certification for use in a hazardous condition. The wireless transceiver has a first discrete input to receive the electrical signal generated by the sensor of the field device and the wireless transceiver communicates the received electrical signal to a wireless interface without an interposing intrinsically safe panel.

### BRIEF DESCRIPTION OF THE DRAWINGS

FIG. 1 depicts a known monitoring system.

FIG. 2 depicts a block diagram of an example wireless monitoring system in accordance with the teachings disclosed herein.

FIG. 3 depicts an example wireless monitoring system described herein.

FIG. 4 depicts a flowchart of an example method for implementing an example wireless monitoring system disclosed herein.

### DETAILED DESCRIPTION

The examples described herein relate to methods and apparatus for wirelessly monitoring pressure safety devices of a process system. More specifically, an example wireless monitoring system described herein employs an intrinsically safe, powered wireless interface or transmitter (e.g., a transceiver) that can be coupled to a sensor of a monitoring device for use in hazardous conditions or environments. As a result, an example wireless monitoring system described herein eliminates the need for wiring a sensor to an intrinsically safe panel that is interposed between, for example, a control room and the sensor of the pressure safety device. Intrinsically safe (IS) is a protection certification for safe operation of a device with electronic equipment in hazardous areas such as, for example, explosive or volatile atmospheres in the petrochemical industry. A device termed “intrinsically safe” is designed and certified to eliminate or encapsulate any components that produce sparks or which could generate enough heat to cause an ignition in areas with flammable gasses, dusts or fuels, etc.

An example monitoring system described herein includes a sensor to monitor a fluid characteristic or parameter of a fluid (e.g. a pressure of the fluid) coupled to a wireless interface or transmitter or transceiver. The wireless transmitter or transceiver may be coupled directly to the sensor and/or may be coupled remotely relative to the sensor. For example, the sensor generates an electrical signal when a fluid parameter sensed by the sensor is greater than or less than (e.g., outside a desired range) a pre-set or predetermined parameter value. The wireless transmitter broadcasts and/or communicates the signal generated by the sensor to a gateway, which configures the signal received from the wireless transmitter and sends the configured signal to a control system or monitoring device via, for example, one or more data busses (Ethernet, Modbus, etc.). In particular, the wireless transmitter provides an intrinsically safe power module that communicates wireless signals to a wireless interface of a control system without the need for an intrinsically safe panel. The example wireless transmitter disclosed herein provides an intrinsically safe certification for use in hazardous locations or areas. Thus, the example monitoring systems described herein eliminate the need for hardwiring a sensor to an intrinsically safe barrier or panel. Additionally, the example monitoring system described herein includes wireless field device interfaces that eliminate the need for and the costs associated with an intrinsically safe barrier or panel. Further, the wireless interface or gateway allows the wireless transmitter to communicate via OPC, Modbus, Ethernet or serial 485 without discrete input cards.

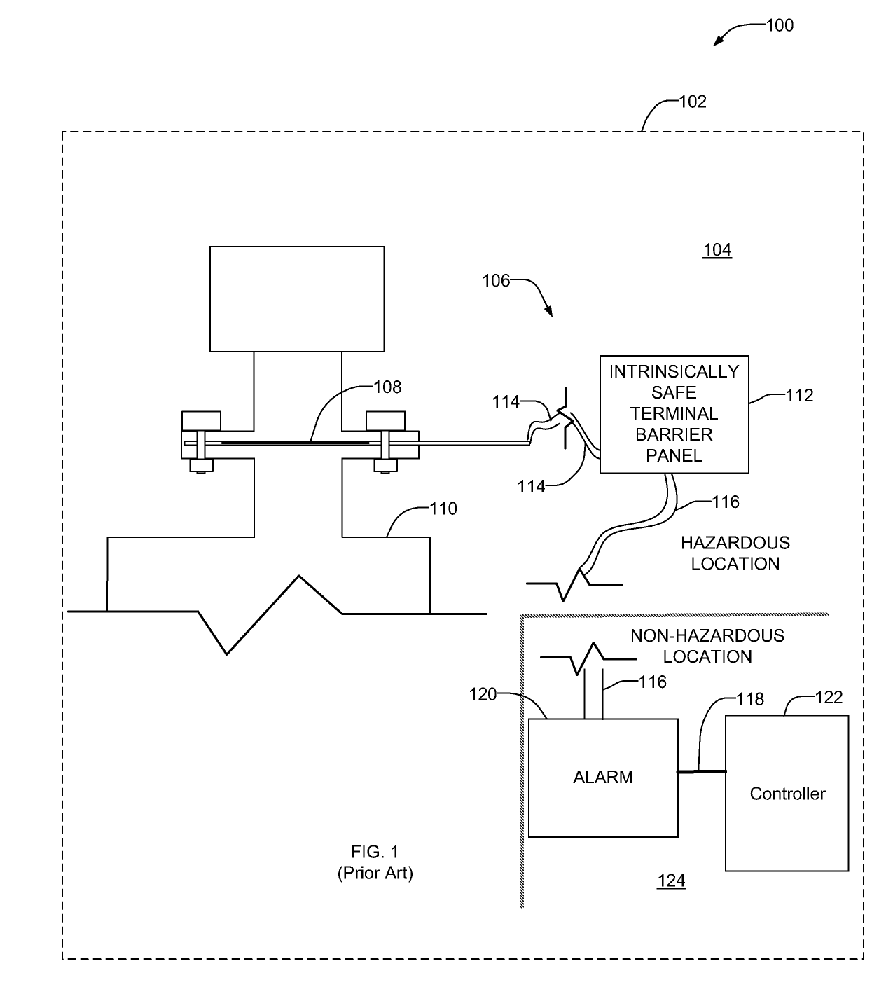

FIG. 1 illustrates a known monitoring system 100 for use with a process system 102 in a hazardous environment 104. More specifically, the monitoring system 100 is implemented with a hardwired communication network 106. In general, communication channels, links and paths that enable the monitoring system 100 to function within the process system 102 are commonly collectively referred to as a communication network. As shown in FIG. 1, the monitoring system 100 includes a sensor 108 (e.g., a burst sensor) coupled to a tank or pressure-vessel 110 to sense a pressure of a fluid (e.g., liquid, gas, etc.) within the tank 110. In hazardous applications (e.g., petrochemical industry, refining industry, power industry, pulp & paper, etc.), the sensor 108 is powered via an intrinsically safe terminal barrier panel 112. The barrier panel 112 provides a protection certification for safe operation with electronic equipment in hazardous (e.g., explosive) atmospheres or conditions. As shown in FIG. 1, the sensor 108 is connected to the barrier panel 112 via wires 114. In turn, the barrier panel 112 is communicatively coupled via wires 116 and 118 to an alarm 120 and/or a controller 122 located remotely from the sensor 108. For example, the alarm 120 and/or the controller 122 are located in a non-hazardous location 124 (e.g., a control room of a process plant). Thus, the monitoring system 100 requires running wires and conduit from the sensor 108 to the barrier panel 112 and from the barrier panel 112 to the controller 122 (e.g., a control room) when the monitoring system 100 is used in a hazardous application.

However, hardwired communication networks are typically expensive to install, particularly in cases where the communication network 106 is associated with a large industrial plant or facility that is distributed over a relatively large area and/or tanks having relatively large heights. In many instances, the wiring associated with the communication network 106 may have to span relatively long distances and/or through, under or around many structures (e.g., walls, buildings, equipment, etc.) Such long wiring runs typically involve substantial amounts of labor and, thus, expense. Further, such long wiring runs are especially susceptible to signal degradation due to wiring impedances and coupled electrical interference, both of which can result in unreliable communications.

In some examples, known wireless communication networks, including the hardware and software associated therewith, provide point-to-point or direct communication paths that are selected during installation and fixed during subsequent operation of the system. Establishing fixed communication paths within these known wireless communication networks typically involves the use of one or more experts to perform an expensive site survey that enables the experts to determine the types and/or locations of transceivers and other communication equipment. Additionally, a signal provided by a point-to-point communication path may be blocked or degraded and, thus, may not be effectively communicated to a receiver or controller, thereby reducing the accuracy and reliability of a monitoring system. Further, such known wireless communication networks often lack an intrinsically safe wireless device and, thus, often require the use of the intrinsically safe terminal barrier panel 112 to provide power and/or communication with a field device or sensor used in a hazardous condition or application.

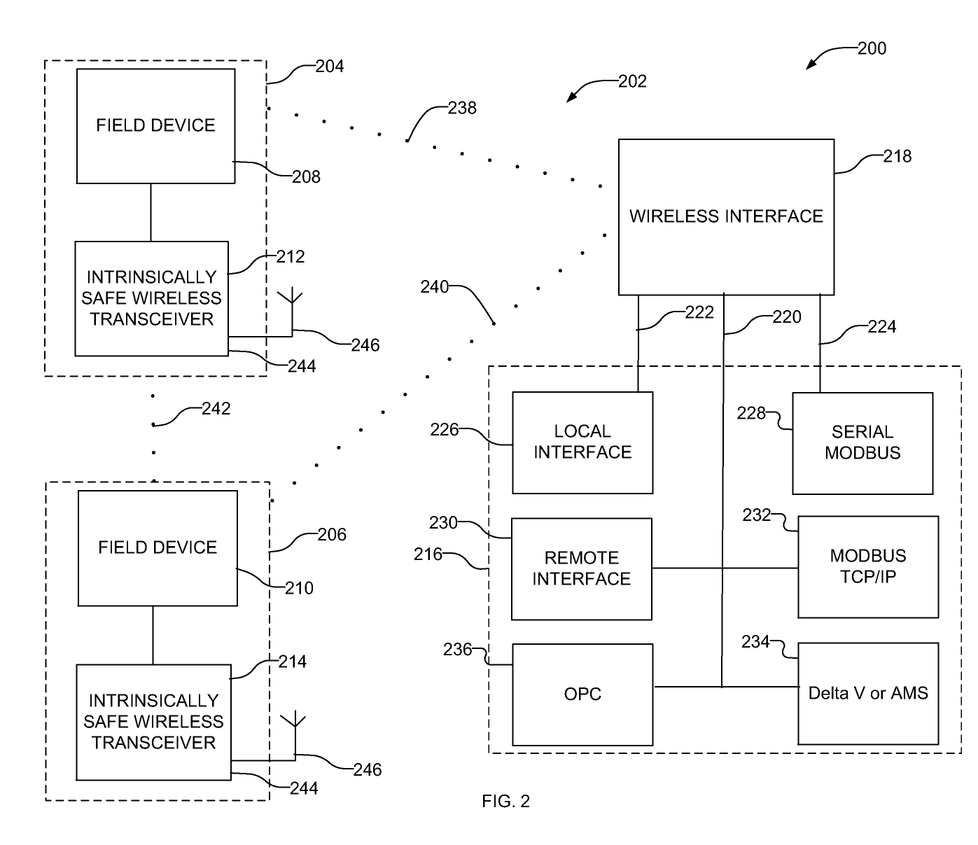

FIG. 2 illustrates a block diaphragm of a portion of a process control system 200 having an example wireless communication network 202 described herein. As shown in FIG. 2, the portion of the process control system 200 includes a plurality of wireless field devices 204 and 206. Each of the wireless field devices 204 and 206 includes respective field devices or sensors 208 and 210 and wireless field device interfaces 212 and 214 (e.g., wireless transceivers). The wireless field device interfaces 212 and 214 broadcast or communicate signals generated by the respective field devices 208 and 210 (e.g., sensors). In general, the wireless field device interfaces 212 and 214 are communicatively coupled to a control system 216 via at least one wireless interface 218 (e.g., a gateway). The wireless interface 218 may serve as a communication hub. The wireless interface 218 may be communicatively coupled to the control system 216 via, for example, an Ethernet connection 220, a Modbus Ethernet connection 222, a serial R485 connection 224 and/or any other suitable connection(s). The wireless interface 218 may also support or make use of communication standards and protocols such as, for example, a local interface 226, a serial modbus 228, a remote interface 230, Modbus TCP/IP 232, Delta V or AMS 234, OPC 236 and/or any other suitable communication standard(s) or protocol(s).

The wireless field device 204 may be a non-smart type field device (e.g., a sensor) that is to perform wireless communications with other similarly enabled wireless field devices such as the wireless field device 210 and/or one or more wireless interfaces such as the wireless interface 218. Specifically, each of the wireless field devices 204 and 206 may be configured to communicate via one or more wireless communication channels, paths or links 238, 240 and 242. Thus, each of the wireless field devices 204 and 206 may communicate with the wireless interface 218 via multiple or redundant communication paths 238, 240 and 242. In general, the wireless field device interfaces 212 and 214 of the respective field devices 208 and 210 may be used to form one or more wireless field nodes 244 of a mesh network. Such wireless field nodes 244 may be remotely located from the control system 216. For example, the first wireless field device interface 212 may be a first field node and the second wireless field device interface 214 may be a second field node of the mesh network. Each of the wireless field device interfaces 212 and 214 may include wireless communication interface circuitry to transmit a signal generated by the respective field devices 208 and 210 and/or receive a signal from the control system 216 via the wireless interface 218. The wireless field device interfaces 212 and/or 214 may communicate via radio signals and/or any desired wireless communication standard or protocol via an antenna 246.

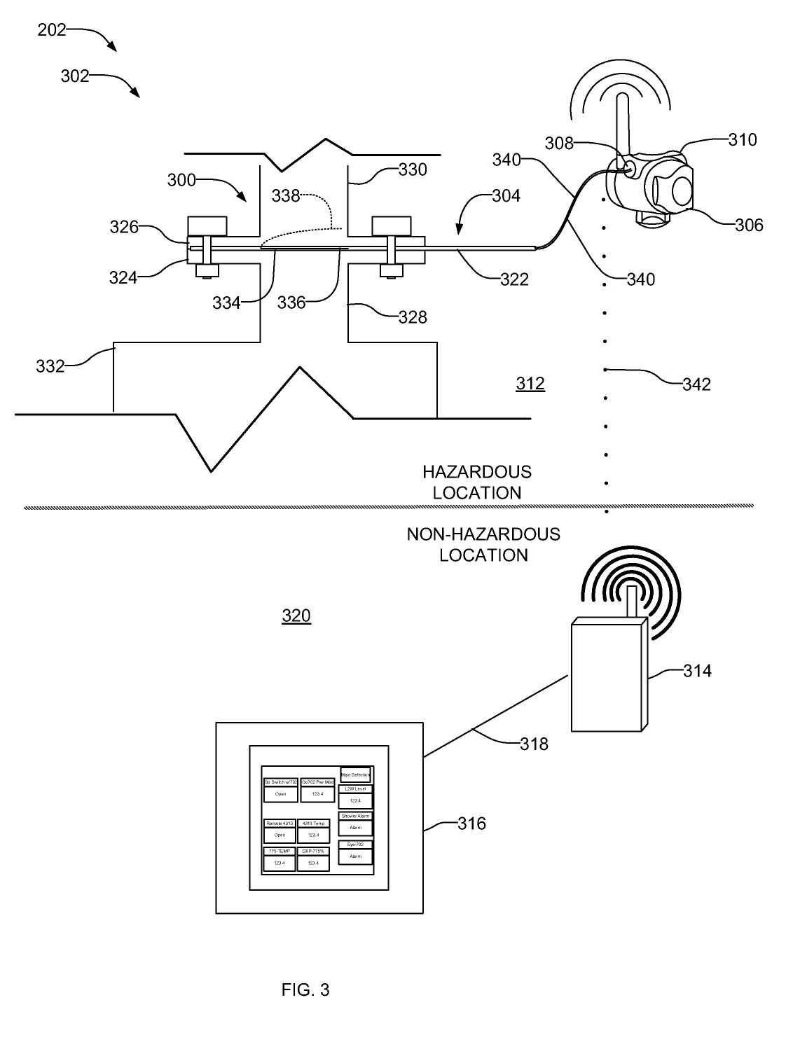

FIG. 3 depicts a portion of the example wireless communication network 202 of FIG. 2 implemented with a wireless field device or monitoring system 300 of a process control system 302 having hazardous process fluids. The wireless monitoring system 300 of FIG. 3 includes a field device 304 coupled to a wireless field device interface or wireless transceiver 306 via a first discrete input 308 (e.g., a simple switch or dry contact input). The wireless transceiver 306 may also include a plurality of discrete inputs to receive a plurality of field devices. In the example shown, the wireless transceiver 306 includes a second input 310 to receive a second field device (not shown).

As shown in FIG. 3, the wireless monitoring system 300 is disposed in a hazardous location or area 312. In addition, the wireless transceiver 306 provides intrinsically safe certification for use in hazardous conditions. The wireless transceiver 306 is a self-powered transmitter that has a self-contained power module (e.g., a battery pack). For example, the wireless transceiver 306 may be a Rosemount 702 wireless transmitter manufactured by Rosemount, Inc. Unlike the known hardwired monitoring system 100 of FIG. 1 or known wireless networks, the wireless monitoring system 300 does not require use of an intrinsically safe barrier panel (e.g., the barrier panel 112 of FIG. 1).

The wireless transceiver 306 is communicatively coupled to a wireless interface or gateway 314. The gateway 314 is coupled to a control system 316 (e.g., a host system, a controller, an alarm, or other system) via a connection 318. For example, the control system 316 may be in a control room located in a non-hazardous location 320. Additionally, similar to the wireless field devices 204 and 206 of FIG. 2, the wireless monitoring system 300 may be a node of a mesh network (e.g., a full or partial mesh topology) and may simultaneously communicate with other wireless enabled field devices and/or wireless interfaces within the process system 302.

The field device 304 of the illustrated example is a burst sensor 322. The burst sensor 322 is coupled between flanges 324 and 326 of respective pipes 328 and 330. The burst sensor 322 senses or monitors a pressure of a fluid (e.g., a fluid parameter or characteristic) within a tank or fluid containment vessel 332. The burst sensor 322 includes a filament 334 that moves from a connected or engaged position 336 to a disengaged or ruptured position 338 (shown in dashed lines) when a pressure within the tank 332 is greater than a desired set point pressure (e.g., a pre-set parameter or value). Thus, the burst sensor 322 provides a switch sensor (not shown) that is electrically coupled to the discrete input 308 of the wireless transmitter 306 via wires 340. The physical connections may provide screw terminals, pluggable connections (e.g., a female or male header), insulation displacement connections and/or any other desired type of electrical connector(s). For example, the Rosemount 702 wireless transmitter can accept input from one or two single pole, single throw switches via the respective first and second discrete inputs. In other examples, the burst sensor 322 and the wireless transmitter 306 may be a unitary structure. Once coupled to the field device 304, a tag or network I.D. representative of the wireless transmitter 306 is assigned in an operator interface or the control system 316 via the gateway 314 so that the particular field device 304 or burst sensor 322 may be monitored via the control system 316.

In operation, when the burst sensor 322 is in the connected position 336, a circuit is complete or closed. A closed circuit or switch generates a logical true output signal. The wireless transmitter 306 broadcasts a logical true output signal to the gateway 314 via a wireless communication path 342 and/or other wireless enabled field devices in the process system 302. The gateway 314, in turn, communicates the same to the control system 316. When the burst sensor 322 is in the ruptured position 338 (e.g., when the pressure within the tank 332 is greater than the rupture rating of the burst sensor 322), the circuit is incomplete or open. An open circuit or switch drives a logical false output signal. The wireless transceiver 306 broadcasts and/or communicates the false output signal (e.g., the open and closed signals) to the gateway 314 via the wireless communication path 342. In turn, the gateway 314 communicates the signal to the control system 316, which may provide an alarm or indication to an operator that a rupture disk associated with the burst sensor 322 has ruptured. For example, the wireless signals provided by the wireless transceiver 306 may be monitored via, for example, HART™ or Modbus tags instead of discrete inputs. Although not shown, in other examples, the field device 304 or sensor may be coupled to safety relief valves to detect pressure or fluid releases.

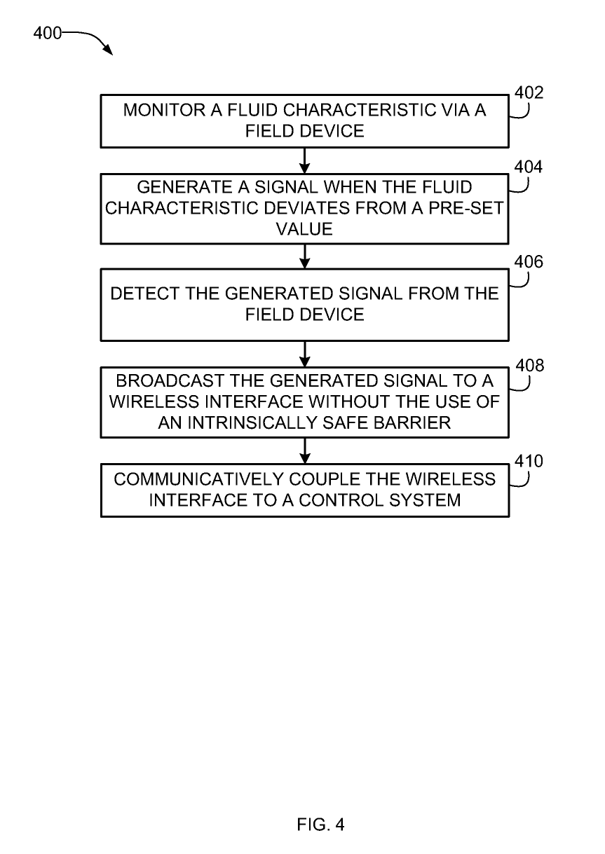

FIG. 4 depicts a flow diagram of an example process 400 that may be used to implement the example wireless monitoring system disclosed herein. The example process 400 begins by monitoring a fluid characteristic or parameter (e.g., a fluid pressure) via a field device (block 402). For example, the field device may monitor a pressure of a fluid within a fluid containment vessel and is configured to generate a signal when the fluid characteristic or parameter deviates from a pre-set value. (block 404). For example, the field device may include a sensor such as, for example, a burst sensor (e.g., the burst sensor 322 of FIG. 3) having a filament that moves to a ruptured position when the pressure in the fluid containment vessel is greater than a pre-determined pressure value. Upon detection of filament moving to the ruptured position, the field device generates an electrical signal.

A wireless transmitter or transceiver coupled to the field device receives or detects the generated signal (406). For example, the field device may be coupled to the wireless transceiver via wires. In this example, the wireless transmitter is powered via a self-contained power module to provide an intrinsically safe certification for use in a hazardous location and without the need for an intrinsically safe barrier.

In turn, the wireless transceiver broadcasts the generated signal (block 408). For example, the wireless transceiver is communicatively coupled to a wireless interface and wirelessly sends the generated signal to the wireless interface. For example, the wireless interface may be a gateway.

In some examples, a control system receives the generated signal from the wireless interface (block 410). For example, the wireless interface may be communicatively coupled to a control system to alert an operator in a control room of the generated signal. In some examples, the control system may be located in a non-hazardous location (e.g., a control room) and the field device and the wireless transceiver may be located in a hazardous location.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A wireless monitoring system, comprising:
a field device;
a wireless transceiver coupled to the field device to receive a signal generated by the field device, the wireless transceiver having a self-contained power module; and
a wireless interface communicatively coupled to the wireless transceiver without an interposing intrinsically safe barrier panel, the wireless interface to wirelessly receive the signal from the wireless transceiver.

2. The system of claim 1, wherein the field device is to monitor a pressure of a fluid within a fluid containment vessel.

3. The system of claim 1, wherein the wireless transceiver has a first discrete input to receive the signal.

4. The system of claim 1, further comprising a control system to be communicatively coupled to the wireless interface.

5. The system of claim 4, wherein the control system is in a non-hazardous location and the field device and the wireless transceiver are located in a hazardous location.

6. The system of claim 1, wherein the field device is a burst sensor coupled between flanges of respective pipes.

7. The system of claim 6, wherein the burst sensor has a filament to move from an engaged position to a disengaged position when a pressure within the fluid containment vessel is greater than a desired set-point pressure, wherein the filament moving to the disengaged position causes the sensor to generate the signal.

8. The system of claim 7, wherein the burst sensor comprises a switch sensor to electronically send the signal to the discrete input of the wireless transceiver when the filament moves to the disengaged position.

9. The system of claim 1, wherein the wireless field device interface further comprises a plurality of discrete inputs to communicatively couple to a plurality of field devices.

10. The system of claim 1, further comprising a plurality of wireless transceivers coupled to a plurality of field devices, a wireless transceiver from the plurality of wireless transceivers is to wirelessly communicate with another wireless transceiver from the plurality of wireless transceivers via one or more wireless communication channels to form a mesh network.

11. A method of monitoring a system, comprising:
monitoring a fluid characteristic of a process fluid via a field device;
communicatively coupling the field device to a wireless transceiver, the wireless transceiver providing an intrinsically safe certification for use in a hazardous location; and
sending a signal generated by the field device to a wireless interface via the wireless transceiver without the use of an intrinsically safe barrier.

12. The method of claim 11, further comprising communicatively coupling the wireless interface to a control system.

13. The method of claim 11, wherein monitoring the fluid characteristic comprises monitoring a pressure of the process fluid within a fluid containment vessel by coupling a burst sensor to the fluid containment vessel, the burst sensor having a filament that moves to a ruptured position when the pressure in the fluid containment vessel is greater than a pre-determined pressure value.

14. The method of claim 13, further comprising electrically sending the signal to the wireless transceiver when the filament moves to the ruptured position.

15. The method of claim 11, further comprising powering the wireless transceiver via a self-contained power module.

16. The method of claim 11, further comprising placing the control system in a control room located in a non-hazardous location and placing the field device and the wireless transceiver in a hazardous location.

17. A wireless field device assembly, comprising:
a field device having a sensor to monitor a fluid parameter of a process fluid, the sensor to generate an electrical signal when the fluid parameter is greater than or less than a pre-set value; and
a wireless transceiver coupled to the field device, the wireless transceiver having a self-contained power module to provide an intrinsically safe certification for use in a hazardous condition, the wireless transceiver having a first discrete input to receive the electrical signal generated by the sensor of the field device, the wireless transceiver to communicate the received electrical signal to a wireless interface without an interposing intrinsically safe panel.

18. The apparatus of claim 17, wherein the field device comprises a burst sensor.

19. The apparatus of claim 18, wherein the burst sensor is to monitor a pressure of the process fluid in a fluid containment vessel, and wherein the electrical signal is generated by the field device to indicate that the pressure in the fluid containment vessel is greater than a desired set point pressure.
